(19) United States
(12) Patent Application Publication
(10) Pub. No.: US 2006/0218407 A1
(43) Pub. Date: Sep. 28, 2006

(54) Method of confirming the identity of a person

(76) Inventor: Alvin David Toms, London (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/239,544

(22) Filed: Sep. 29, 2005

(30) Foreign Application Priority Data
Jun. 16, 2005 (AU) 2005903141
Mar. 24, 2005 (AU) 2005901441

(51) Int. Cl. H04L 9/00; H04K 1/00

(52) U.S. Cl. 713/182; 713/183; 713/186

(57) ABSTRACT

Methods and systems for confirming the identity of a person include receiving identifying information of the person, receiving an electronic device identifier, checking a database for a recorded association between the identifying information and the electronic device identifier and indicating that the identity is or is not confirmed in the event that there is or is not an association between the identifying information and the electronic device identifier.

### RELATED APPLICATIONS

This application claims priority to, and incorporates by reference, the entire disclosure of Australian Provisional Application No. 2005903141, filed on Jun. 16, 2005 and Australian Provisional Application No. 2005901441, filed on Mar. 25, 2005.

### FIELD OF INVENTION

The present invention relates to confirming the identity of a person.

### BACKGROUND

It is often difficult to confirm the identity of a person for many reasons. Some people do not have photograph identification, and even those that have photo-identification can have it stolen. Also photo identification can be forged.

The present invention provides a new way of confirming the identity of a person, which can be used alone or in combination with other methods.

### BRIEF SUMMARY OF THE INVENTION

According to one aspect of the invention there is provided a method of confirming the identity of a person, the method comprising receiving identifying information of the person, receiving an electronic device identifier, checking a database for a recorded association between the identifying information and the electronic device identifier and indicating that the identity is confirmed in the event that there is an association between the identifying information and the electronic device identifier.

In a preferred embodiment the method further comprises contacting the person using the electronic device having the received electronic device identifier and indicating that the identity is confirmed in the event that there is an association between the identifying information and the electronic device identifier and the person is successfully contacted.

In a further preferred embodiment the method further comprises contacting the person via the electronic device having the received electronic device identifier using its electronic device identifier to confirm it is in the person's possession and indicating that the identity is confirmed in the event that there is an association between the identifying information and the electronic device identifier, the person is successfully contacted and confirmation is received that the electronic device is in the person's possession.

In a further preferred embodiment the method further comprises checking for a negative indication that the electronic device having the received electronic device identifier is in the possession of its owner or a rightful person and indicating that the identity is confirmed in the event that there is an association between the identifying information and the electronic device identifier, the person is successfully contacted and there is no negative indication relating to the possession of the electronic device.

According to a second aspect of the present invention there is provided a method of confirming the identity of a person, the method comprising receiving identifying information of the person, receiving an electronic device identifier, checking a database for a recorded association between the identifying information and the electronic device identifier and indicating that the identity is not confirmed in the event that there is no association between the identifying information and the electronic device identifier.

In a preferred embodiment the method further comprises contacting the person via the electronic device having the received electronic device identifier using its electronic device identifier and indicating that the identity is not confirmed in the event that the person is not successfully contacted.

In a further preferred embodiment the method further comprises contacting the person via the electronic device having the received electronic device identifier using its electronic device identifier to confirm it is in the person's possession and indicating that the identity is not confirmed in the event that the person is not successfully contacted or confirmation is not received that the electronic device is in the person's possession.

In a further preferred embodiment the method further comprises checking for a negative indication that the electronic device having the received electronic device identifier is in the possession of its owner or a rightful person and indicating that the identity is not confirmed in the event that there is a negative indication relating to the possession of the electronic device.

Typically the method further comprises indicating that the identity is confirmed in the event that there is an association between the identifying information and the electronic device identifier, the person is successfully contacted, confirmation is received that the electronic device is in the person's possession and there is no negative indication relating to the possession of the electronic device.

Preferably the electronic device is a telephone and the electronic device identifier is a phone number.

Usually the identifying information is one or more of a name of the person, an address of the person, a social security number of the person, a password, pass-phrase or PIN, and/or a biometric reading.

A negative indication relating to the possession of the device is given in the event that the device is logged as being lost, stolen or suspected of being lost or stolen.

According to a third aspect of the present invention there is provided a system for confirming the identity of a person, the system comprising means for receiving identifying information of the person means for receiving an electronic device identifier storage means for holding a database recording associations between identifying information of people and electronic device identifiers means for checking the database for a recorded association between the received identifying information and the received electronic device identifier and identity confirmation means for indicating that the identity is confirmed in the event that there is an association between the identifying information and the electronic device identifier.

In a preferred embodiment the system further comprises means for contacting the person via the electronic device having the received electronic device identifier using its electronic device identifier, wherein the identity confirmation means indicates that the identity is confirmed in the event that there is an association between the identifying information and the electronic device identifier and the person is successfully contacted.

In a further preferred embodiment the system further comprises means for contacting the person via the electronic device having the received electronic device identifier using its electronic device identifier to confirm it is in the person's possession, wherein the identity confirmation means indicates that the identity is confirmed in the event that there is an association between the identifying information and the electronic device identifier, the person is successfully contacted and confirmation is received that the electronic device is in the person's possession.

In a further preferred embodiment the system further comprises means for checking for a negative indication that the electronic device having the received electronic device identifier is in the possession of its owner or a rightful person, wherein the identity confirmation means indicates that the identity is confirmed in the event that there is an association between the identifying information and the electronic device identifier, the person is successfully contacted and there is no negative indication relating to the possession of the electronic device.

### DESCRIPTION OF DIAGRAMS

In order to provide a better understanding of the present invention preferred embodiments will now be described in greater detail, by way of example only, with reference to the accompanying diagrams, in which:

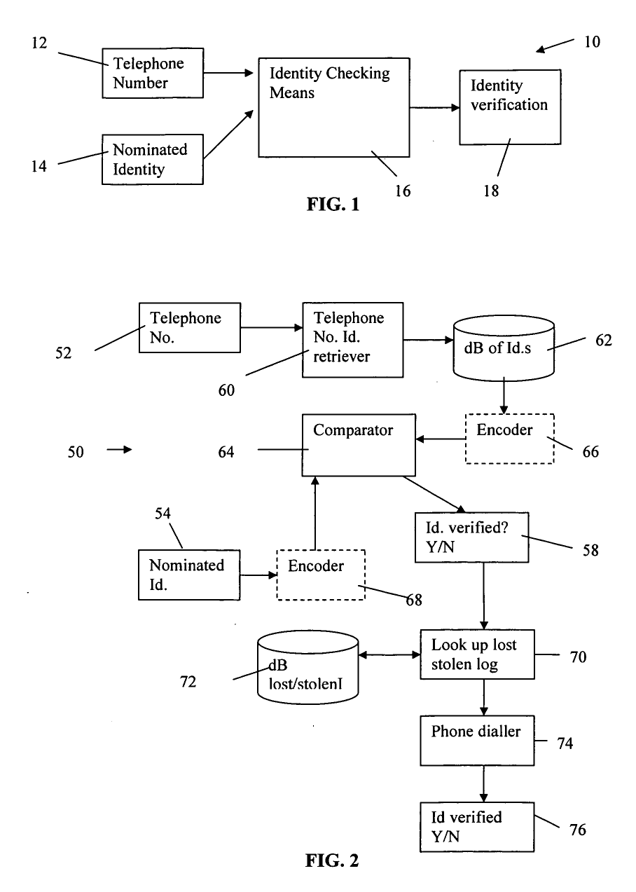

FIG. 1 is a schematic block diagram of a system for confirming the identity of a person according to a preferred form of the present invention;

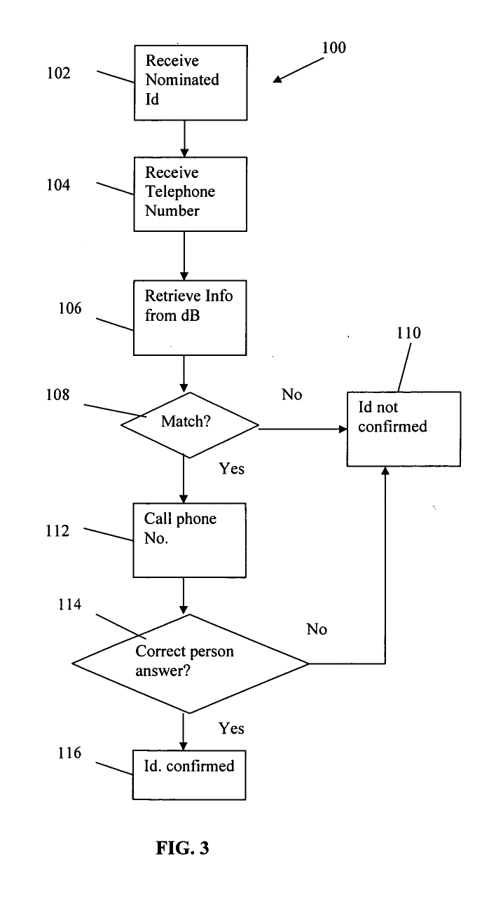

FIG. 2 is a schematic block diagram of a system for confirming the identity of a person according to another embodiment of the present invention; and

FIG. 3 is a schematic flow chart of one embodiment of a method of performing the present invention.

### DETAILED DESCRIPTION OF PREFERRED EMBODIMENTS

The present invention confirms or assists in conforming the identity of a person. The present invention can be used by providers of credit, such as banks and the like and companies that provide goods or services in advance of payment, such as telecommunications companies.

Most telephone numbers are closely associated with a specific person or group of people for long periods because people are reluctant to change their telephone numbers. This means that information associated with a telephone (such as the phone number) typically describes the person or group of people who are normally associated with the telephone, and their behaviour.

This is also applicable to identifiers of electronic devices other than telephones, such as a computer identifier or a PDA identifier. The electronic device identifier could be an Internet Protocol address that is being used to access the service, or some other identifier of the hardware such as a MAC address.

Referring to FIG. 1, a simplified form of a system for providing identity verification 10 is shown. It includes an input means 12 for receiving an electronic device identifier such as a telephone number, an input means 14 for receiving a nominated identity, an identity checking means 16, and an output means 18 for providing an indication as to whether the identity nominated is verified based on the telephone number supplied.

The input means 12 and 14 will usually be in the form of a keyboard connected to a computer system. The identity checking means 16 will usually be in the form of a second computer system connected to the first computer system by a network, although it may be one and the same computer system. The first computer system will be arranged to provide the inputted telephone number and nominated identity to the second computer system, which will check the identity as will be described below. The second computer system is arranged to provide an indication of whether the identity is confirmed or not to the first computer system. The output means 18 will usually be in the form of a display screen of the first computer system. It will be appreciated that the roles of the first and second computer systems could be performed by a single computer system or by many computer systems.

The computer systems which perform the method described herein operate under the control of one or more computer programs that configure and direct the computer systems to perform the invention. The computer program(s) may be stored on a computer readable storage medium, such as an installed memory device or a disk drive for access by the computer processor during operation, or on a removable medium, such as a floppy disk, CD, DVD, flash memory stick, etc. for loading onto the computer system.

Referring to FIG. 2, which shows the identity checking means 16 of the system 50 (10 in FIG. 1) in more detail. The identity checking means 16 comprises a means for retrieving the identity 60 serviced by the telephone number (usually the account holder) and a comparator 64. The means for retrieving the identity 60 will usually be in the form of an identity requesting means and an identity retrieving means. A telecommunications company will usually operate the identity retrieving means, whereas the credit provider will usually operate the identity requesting means (especially if they are not the same entity). The identity requesting means is configured to request the identity serviced by the telephone number from the identity retrieving means. Upon receipt of this request, the identity retrieving means is configured to access a database stored on a storage means 62 and retrieve the identity details (name, address, etc.) from the database.

Telecommunications databases usually contain three types of information:
(i) Customer data. This data relates to the specific personal details of individual subscribers and/or authorised users of a telephone service. The personal details would typically include information such as names, personal and work addresses, previous personal addresses, marital statuses, employment statuses, ages, bank account details, payment plan details, alternative contact numbers, job title, etc. Different telecommunications databases may contain more or less information than that described above depending on the types of services being offered by the network operator and the intensity of their application risk management programmes. Advanced operators may store voiceprints that can be used to perform speaker verification prior to the provision of restricted high value services such as international calling.
(ii) Usage data. This data relates to how the services offered to a particular subscriber or group of subscribers are used. Typically this data will contain information about the values of calls made, the durations of calls, their density, the types of number dialed, the cells sites from which calls were made, etc. Various operators may extract more or less data than this depending on the level of sophistication of their data mining capabilities, and the extent to which they are able to use the data they extract for fraud detection and prevention, active selling, dynamic credit allocation, behavioural risk scoring, and similar applications. Advanced operators may dynamically build a database of voiceprints of users of a service, usually for the purposes of fraud detection. All data may relate to recent behaviour but some operators may also retain historical data for the purposes of identifying changes in behaviour.
(iii) Payment data. This data relates to the size, timing, and methods by which payments are made for the services consumed. Typically this data will contain information about whether payments tend to be made in part of in full, whether they tend to be early or late, whether they are by cheque, direct debit, standing order, credit card, etc. Historical data may be obtained so that trends and changes in behaviour can be identified, and may be used for a variety of purposes such as behavioural risk scoring, and dynamic credit allocation.

The databases used by banks and credit card companies contain natural analogues of all of the above data types, most of which will be readily identifiable to those familiar with the banking and financial industries. For example, the customer data retained by a credit card operators will contain substantially the same information as that used by a telecommunications operator. If the credit limit offered by the card operators is high, however, they may be more diligent in collecting the information, and may add to it using sources such as credit bureaus in order to further reduce their risk. The usage data that is collected by credit card operators may be less rich than that collected by telecommunications operators, simply because there are fewer descriptors associated with a credit card transaction than with a telephone call. For example, credit card transactions may be summarized in terms of time, location, and value. The payment data stored by credit card issuers is again substantially the same as the payment data stored by telecommunications network operators because the means by which payment can be made may be essentially the same in each case.

The retrieved identity is sent to the comparator 64. The comparator 64 compares the identity provided by input means 14 with the identity provided by the identity retrieving means. In the event that the identities match a positive indication is provided to the output means 58. In the event that the identities do not match a negative indication is provided to the output means 58.

The comparator 66 may be configured to provide an indication of a partial match to the output means 18, when the identity details partially match. For example, the telephone account may be in the name of one family member, but the person being identified may be a different person residing in the same residence or having the same surname. A partial match may be given in those circumstances. Details of the extent of the match may also be given.

Privacy laws or concerns may be addressed by the telecommunications company encoding the identity retrieved from the database by using an encoder 66. The encoder can use a suitable technique, such as hashing, to obtain data representing the identity. The data may not be reversible back to the identity, but would be created in a manner such that it would be highly unlikely that a different identity being encoded would create the same data. The operator of the credit facility would encode the identity details provided by the applicant using encoder 68, using the same encoding technique, in order to compare the resulting data. To improve the robustness of the comparison, identity information can be subject to a series of normalisation procedures prior to encoding, such as converting text into a phonetic representation in order to minimise the effects of misspelling by data entry operators. A sophisticated comparator and encoder arrangement may be able to determine a degree of match from the encoded identity details.

Further optional parts to the system 50 may be provided. This may include a lookup means 70 for checking a database on a storage means 72 for a record on whether the phone is logged as lost or stolen.

Another optional part is a telephone dialler 74 which dials the phone number given to check that the person being identified can be contacted. This may be done in person in one embodiment to see if the phone rings and is answered by the person in front of the person confirming the identity. Otherwise other mechanisms manual or automatic may be used. For example a password/phase/PIN could be requested and verified or a biometric reading taken by the phone or a device associated therewith.

If these checks are passed then an indication confirming the identity is output by output means 76, which is in turn provided to output means 18.

Referring to FIG. 3, the method 100 of use of one embodiment of the present invention using the system of FIG. 1 will now be described. The person being identified may have for example requested an unsecured credit facility, such as the provision of a service (for example a new telephone service) or the provision of a loan. As part of the credit application process the credit applicant needs to have their identity verified. There may be other reasons for verifying the identity of the person. The person provides their nominated identity 102 by input means 14 and supplies their telephone number (which may be for a land line or a mobile telephone) at 104. This is entered into the input means 12.

The identity checking means 16 may normalise telephone number format to eliminate possible confusions that can occur when the same number can be represented in several different ways.

For example, the same telephone number can typically be given at the level of the local exchange (for example, 534489), at the level of the regional exchange (for example, 01477534489) or at the level of national interconnect (for example 00441477534489). This normalisation process can be performed using industry standard techniques that are based on segmenting the number to identify missing elements that can then be supplied from lookup tables.

If the embodiment of FIG. 2 is used the lookup means 60 retrieves the information associated with the telephone number from the storage means 62 at step 106.

The nominated identity is compared 108 to that retrieved for the storage means 62. If the nominated identity does not match that retrieved identity, then the identity is not confirmed at 110. At this stage a check can also be preformed to determine whether the telephone is logged as being lost or stolen in a database of the telecommunications company. If the phone is lost or stolen then the identity is not confirmed 110.

The telephone number is then contacted 114 to see whether the nominated person has the phone in their possession. This may occur simply by determining who answers. Questions may be asked to see if the credit applicant has the phone in their possession. For example a password or phase may be given. Contact of the user of the telephone does not necessarily occur simply through a voice call; text messaging is also appropriate.

This process can be conducted manually or automatically. In one form of automation of this process, a voice print can be taken and compared to a sample to confirm the identity of the person. Other biometric readings can also be used either to confirm the phone is in the possession of the person or as the nominated identity (in which case the input means 14 will be a biometric reader and lookup database).

If the correct person is not in possession of the phone, then the identity is not confirmed 110. Otherwise the identity is confirmed 116. The conformation or non confirmation is given by output means 18.

The present invention can be used in developing countries where the information infrastructure is extremely limited, making it difficult to verify a person's identity by other means.

The skilled addressee will readily appreciate that numerous modifications and variations may be made to the present invention without departing from the basic inventive concept. Such a modification may include:
using an electronic device identification number rather than the telephone number. For example an Internet Protocol (IP) address could be used where the IP address has an associated payment/use history with an internet service provider. In cases where a dynamic IP address is provided another unique identifier can be used such as a network interface card or microprocessor address/identifier (e.g. MAC address or processor serial number) This is particularly useful if the application for credit is conducted on-line, since the identifier can be automatically provided to the input means 12.
it is envisaged that convergence of telephone devices and personal computing devices will at some point eliminate the difference between a telephone number and a device address. For this reason an electronic device identifier is intended to include any identification of a device to which relevant information can be associated for performing an identity check.

All of those modifications and variations as would be apparent to the skilled addressee are intended to fall within the scope of the present invention, the nature of which is to be determined by the foregoing description and appended claims.

1. A method of confirming the identity of a person, the method comprising:
receiving identifying information of the person;
receiving an electronic device identifier;
checking a database for a recorded association between the identifying information and the electronic device identifier;
indicating that the identity is confirmed in the event that there is an association between the identifying information and the electronic device identifier.

2. A method according to claim 1, wherein the method further comprises:
contacting the person using the electronic device having the received electronic device identifier;
indicating that the identity is confirmed in the event that there is an association between the identifying information and the electronic device identifier and the person is successfully contacted.

3. A method according to claim 1, wherein the method further comprises:
contacting the person via the electronic device having the received electronic device identifier using its electronic device identifier to confirm it is in the person's possession;
indicating that the identity is confirmed in the event that there is an association between the identifying information and the electronic device identifier, the person is successfully contacted and confirmation is received that the electronic device is in the person's possession.

4. A method according to claim 1, wherein the method further comprises:
checking for a negative indication that the electronic device having the received electronic device identifier is in the possession of its owner or a rightful person;
indicating that the identity is confirmed in the event that there is an association between the identifying information and the electronic device identifier, the person is successfully contacted and there is no negative indication relating to the possession of the electronic device.

5. A method of confirming the identity of a person, the method comprising:
receiving identifying information of the person;
receiving an electronic device identifier;
checking a database for a recorded association between the identifying information and the electronic device identifier;
indicating that the identity is not confirmed in the event that there is no association between the identifying information and the electronic device identifier.

6. A method according to claim 5, wherein the method further comprises:
contacting the person via the electronic device having the received electronic device identifier using its electronic device identifier;
indicating that the identity is not confirmed in the event that the person is not successfully contacted.

7. A method according to claim 5, wherein the method further comprises:
contacting the person via the electronic device having the received electronic device identifier using its electronic device identifier to confirm it is in the person's possession;
indicating that the identity is not confirmed in the event that the person is not successfully contacted or confirmation is not received that the electronic device is in the person's possession.

8. A method according to claim 5, wherein the method further comprises:
checking for a negative indication that the electronic device having the received electronic device identifier is in the possession of its owner or a rightful person;
indicating that the identity is not confirmed in the event that there is a negative indication relating to the possession of the electronic device.

9. A method according to claim 5, wherein the method further comprises indicating that the identity is confirmed in the event that there is an association between the identifying information and the electronic device identifier, the person is successfully contacted, and there is no negative indication relating to the possession of the electronic device.

10. A method according to claim 5, wherein the electronic device is a telephone and the electronic device identifier is a phone number.

11. A method according to claim 5, wherein the identifying information is one or more of:
a name of the person;
an address of the person;
a social security number of the person;
a password, pass-phrase or PIN; and/or
a biometric reading.

12. A method according to claim 5, wherein a negative indication relating to the possession of the device is given in the event that the device is logged as being lost, stolen or suspected of being lost or stolen.

13. A system for confirming the identity of a person, the system comprising:
means for receiving identifying information of the person;
means for receiving an electronic device identifier;
storage means for holding a database recording associations between identifying information of people and electronic device identifiers;
means for checking the database for a recorded association between the received identifying information and the received electronic device identifier;
identity confirmation means for indicating that the identity is confirmed in the event that there is an association between the identifying information and the electronic device identifier.

14. A method according to claim 13, wherein the system further comprises:
means for contacting the person via the electronic device having the received electronic device identifier using its electronic device identifier;
wherein the identity confirmation means indicates that the identity is confirmed in the event that there is an association between the identifying information and the electronic device identifier and the person is successfully contacted.

15. A method according to claim 13, wherein the system further comprises:
means for contacting the person via the electronic device having the received electronic device identifier using its electronic device identifier to confirm it is in the person's possession;
wherein the identity confirmation means indicates that the identity is confirmed in the event that there is an association between the identifying information and the electronic device identifier, the person is successfully contacted and confirmation is received that the electronic device is in the person's possession.

16. A method according to claim 13, wherein the system further comprises:
means for checking for a negative indication that the possession of the electronic device having the received electronic device identifier is in the possession of its owner or a rightful person;
wherein the identity confirmation means indicates that the identity is confirmed in the event that there is an association between the identifying information and the electronic device identifier, the person is successfully contacted and there is no negative indication relating to the possession of the electronic device.

17. A system of confirming the identity of a person, the system comprising:
means for receiving identifying information of the person;
means for receiving an electronic device identifier;
storage means for holding a database recording associations between identifying information of people and electronic device identifiers;
means for checking the database for a recorded association between the identifying information and the electronic device identifier;
identify confirmation means for indicating that the identity is not confirmed in the event that there is no association between the identifying information and the electronic device identifier.

18. A method according to claim 17, wherein the system further comprises:
means for contacting the person via the electronic device having the received electronic device identifier using its electronic device identifier;
wherein the identify conformation means indicates that the identity is not confirmed in the event that the person is not successfully contacted.

19. A method according to claim 17, wherein the system further comprises:
means for contacting the person via the electronic device having the received electronic device identifier using its electronic device identifier to confirm it is in the person's possession;
wherein the identify conformation means indicates that the identity is not confirmed in the event that the person is not successfully contacted or confirmation is not received that the electronic device is in the person's possession.

20. A method according to claim 17, wherein the system further comprises:
means for checking for a negative indication that the electronic device having the received electronic device identifier is in the possession of its owner or a rightful person;
wherein the identify conformation means indicates that the identity is not confirmed in the event that there is a negative indication relating to the possession of the electronic device.

21. A method according to claim 17, wherein the identify conformation means indicates that the identity is confirmed in the event that there is an association between the identifying information and the electronic device identifier, the person is successfully contacted, and there is no negative indication relating to the possession of the electronic device.
